(19) United States
(12) Patent Application Publication
(10) Pub. No.: US 2025/0393042 A1
(43) Pub. Date: Dec. 25, 2025

(54) UE CAPABILITY REPORTING AND BD/CCE LIMIT DETERMINATION WITH MULTI-CELL SCHEDULING DCI

(71) Applicant: Apple Inc., Cupertino, CA (US)

(72) Inventors: Sigen Ye, San Diego, CA (US); Ankit Bhamri, Bad Nauheim (DE); Dawei Zhang, Saratoga, CA (US); Haitong Sun, Saratoga, CA (US); Huaning Niu, San Jose, CA (US); Oghenekome Oteri, San Diego, CA (US); Wei Zeng, Saratoga, CA (US); Wei Zhang, Santa Clara, CA (US)

(21) Appl. No.: 19/111,890

(22) PCT Filed: Sep. 20, 2023
(86) PCT No.: PCT/US2023/033239

§ 371 Date: Mar. 14, 2025

Related U.S. Application Data
(60) Provisional application No. 63/409,640, filed on Sep. 23, 2022.

(51) Int. Cl. H04W 72/1268; H04L 27/26; H04W 72/23

(52) U.S. Cl. CPC H04W 72/1268; H04L 27/26025; H04W 72/23

(57) ABSTRACT

A processor and a user equipment (UE) are provided. The processor has circuitry that executes instructions to cause a UE to perform operations. The operations include: determining a capability of communicating with a base station using a plurality of cells; identifying, among the plurality of cells, one or more groups of cells, wherein the cells in each group are schedulable by a same downlink control information (DCI) signal in a scheduling cell; determining a number of the one or more groups; and reporting the number of the one or more groups to the base station.

### CLAIM OF PRIORITY

The present application claims priority of U.S. Provisional Patent Application No. 63/409,640, filed on Sep. 23, 2022, entitled “UE CAPABILITY REPORTING AND BD/CCE LIMIT DETERMINATION WITH MULTI-CELL SCHEDULING DCI,” which is herein incorporated by reference in its entirety.

### BACKGROUND

Wireless communication networks provide integrated communication platforms and telecommunication services to wireless user devices. Example telecommunication services include telephony, data (e.g., voice, audio, and/or video data), messaging, internet-access, and/or other services. The wireless communication networks have wireless access nodes that exchange wireless signals with the wireless user devices using wireless network protocols, such as protocols described in various telecommunication standards promulgated by the Third Generation Partnership Project (3GPP). Example wireless communication networks include code division multiple access (CDMA) networks, time division multiple access (TDMA) networks, frequency-division multiple access (FDMA) networks, orthogonal frequency-division multiple access (OFDMA) networks, Long Term Evolution (LTE), and Fifth Generation (5G) New Radio (NR). The wireless communication networks facilitate mobile broadband service using technologies such as OFDM, multiple input multiple output (MIMO), advanced channel coding, massive MIMO, beamforming, and/or other features.

A user device, such as user equipment (UE), communicates with an access node, such as a base station, in one or more cells. In recent communication technologies, the cells are often referred to as component carriers (CCs). Each cell corresponds to a subcarrier spacing (SCS), also referred to as numerology. A UE and a base station can communicate in communication channels, such as physical uplink shared channel (PUSCH) and physical downlink shared channel (PDSCH), using one or more cells. These channels need to be scheduled so resources are allocated for the communication.

### SUMMARY

In accordance with one aspect of the present disclosure, a processor has circuitry that executes instructions to cause a UE to perform operations. The operations include determining a capability of communicating with a base station using a plurality of cells. The operations include identifying, among the plurality of cells, one or more groups of cells, wherein the cells in each group are schedulable by a same downlink control information (DCI) signal in a scheduling cell. The operations include determining a number of the one or more groups. The operations include reporting the number of the one or more groups to the base station.

In some implementations, the operations further include determining a maximum number of the cells in each group; and reporting the maximum number of the cells in each group to the base station.

In some implementations, the operations further include determining a capability that the cells in each group include the scheduling cell; and reporting the capability to the base station.

In some implementations, the operations further include determining a capability that the cells in each group do not include the scheduling cell; and reporting the capability to the base station.

In some implementations, the operations further include determining a capability that the cells in each group have a same SCS; and reporting the capability to the base station.

In some implementations, the operations further include determining a capability that the cells in each group have different SCSs; and reporting the capability to the base station.

In some implementations, the operations further include determining a capability that the scheduling cell has the same SCS as the SCS of the cells in each group; and reporting the capability to the base station.

In some implementations, the operations further include determining a capability that the scheduling cell has a SCS that is different from the SCS of at least one of the cells in each group; and reporting the capability to the base station.

In some implementations, the reported number includes at least one of: a maximum number of groups of cells supported by the UE; a maximum number of groups of cells supported by each of a first frequency range (FR) and a second FR; a maximum number of groups of cells collectively supported by a plurality of bands; or a maximum number of groups of cells supported by each of the plurality of bands.

In some implementations, the reported maximum number of the cells in each group includes at least one of: a maximum number of the cells in each group supported by the UE; a maximum number of the cells in each group supported by each of a first FR and a second FR; a maximum number of the cells in each group collectively supported by a plurality of bands; or a maximum number of the cells in each group supported by each of the plurality of bands.

In accordance with one aspect of the present disclosure, a UE has a memory, a processor, and a transmitter. The processor, when executing instructions stored in the memory, causes the UE to determine a capability of communicating with a base station using a plurality of cells. The processor causes the UE to identify, among the plurality of cells, one or more groups of cells, wherein the cells in each group are schedulable by a same DCI signal in a scheduling cell. The processor also causes the UE to determine a number of the one or more groups. The transmitter reports the number of the one or more groups to the base station.

In some implementations, the processor determines a maximum number of the cells in each group, and the transmitter reports the maximum number of the cells in each group to the base station.

In some implementations, the processor determines a capability that the cells in each group include the scheduling cell, and the transmitter reports the capability to the base station.

In some implementations, the processor determines a capability that the cells in each group do not include the scheduling cell, and the transmitter reports the capability to the base station.

In some implementations, the processor determines a capability that the cells in each group have a same SCS, and the transmitter reports the capability to the base station.

In some implementations, the processor determines a capability that the cells in each group have different SCSs, and wherein the transmitter reports the capability to the base station.

In some implementations, the processor determines a capability that the scheduling cell has the same SCS as the SCS of the cells in each group, and the transmitter reports the capability to the base station.

In some implementations, the processor determines a capability that the scheduling cell has a SCS that is different from the SCS of at least one of the cells in each group, and the transmitter reports the capability to the base station.

In some implementations, the reported number includes at least one of: a maximum number of groups of cells supported by the UE; a maximum number of groups of cells supported by each of a first FR and a second FR; a maximum number of groups of cells collectively supported by a plurality of bands; or a maximum number of groups of cells supported by each of the plurality of bands.

In some implementations, the reported maximum number of the cells in each group includes at least one of: a maximum number of the cells in each group supported by the UE, a maximum number of the cells in each group supported by each of a first FR and a second FR, a maximum number of the cells in each group collectively supported by a plurality of bands, or a maximum number of the cells in each group supported by each of the plurality of bands.

The details of one or more implementations of these systems and methods are set forth in the accompanying drawings and the description below. Other features, objects, and advantages of these systems and methods will be apparent from the description and drawings, and from the claims.

### BRIEF DESCRIPTION OF THE FIGURES

FIG. 1 illustrates a wireless network, according to some implementations.

FIGS. 2-4 each illustrate a scenario where a plurality of cells are scheduled by various DCI signals, according to some implementations.

FIGS. 5A-5B and 6A-6B each illustrate a flowchart of an example method, according to some implementations.

FIG. 7 illustrates a UE, according to some implementations.

FIG. 8 illustrates an access node, according to some implementations.

### DETAILED DESCRIPTION

PUSCH and PDSCH communications are scheduled by DCI. A base station, such as an e-NodeB (eNB) or a g-NodeB (gNB), can transmit a DCI signal in a cell to a UE to schedule PUSCH or PDSCH communications in one or more cells. The cell in which the DCI signal is transmitted is referred to as the scheduling cell, and the one or more cells in which there are data transmissions (e.g., PUSCH or PDSCH transmissions) scheduled by the DCI signal are referred to as scheduled cells. A data transmission in a cell can be scheduled by a DCI signal transmitted in that cell. This mechanism is referred to as self-scheduling. A data transmission in a cell can also be scheduled by a DCI signal transmitted in another cell. This mechanism is referred to as cross-scheduling.

Conventionally, a single DCI signal can only schedule one cell. This type of DCI is referred to as single-cell DCI. With the development of wireless technology, it is desirable for a UE to support reception of scheduling of data transmissions in multiple cells using a single DCI signal to improve communication efficiency. This type of DCI is referred to as multi-cell DCI. The cells scheduled by a single multi-cell DCI signal are referred to as co-scheduled cells.

A UE can be configured with multiple groups of cells, and each group of cells can be scheduled by a multi-cell DCI signal. To schedule PUSCH or PDSCH communications with multi-cell DCI, the base station would want to obtain information about the UE's capability, such as the maximum number of cells in a group or the maximum number of groups. Thus, it is desirable to have a mechanism for the UE to report its capability relating to multi-cell DCI scheduling.

In addition, a UE monitors the cells for possible DCI signals transmitted in a downlink control channel, such as physical downlink control channel (PDCCH). The downlink control channel has a number of resource candidates, which correspond to a number of blind decoding or control channel elements (BD/CCEs), for the DCI transmission. Because monitoring too many resource candidates may be impractical for the UE, there typically is an upper limit of BD/CCEs set for the monitored cells. In conventional single-cell DCI scheduling, the upper limit can be directly determined based on the SCS of a scheduled cell. For example, the maximum number of BDs per cell per slot for SCS of 30 kHz (numerology μ=1) is provided as 36, and the maximum number of BDs per cell per slot for SCS of 120 kHz (numerology μ=3) is provided as 20.

With multi-cell DCI scheduling, one DCI signal can simultaneously schedule multiple cells that the UE monitors. As such, instead of counting the BD/CCEs separately for each schedulable/scheduled cell, it may be advantageous to count the BD/CCEs provided for the cells schedulable by multi-cell DCI towards the scheduling cell, i.e., as if the BD/CCEs are provided for the scheduling cell. This counting approach thus calls for a mechanism for the UE to determine the upper limit of BD/CCEs in each cell for multi-cell DCI scheduling.

This disclosure is made in light of the above challenges. As described in detail below, implementations of this disclosure provide mechanisms for a UE to report its capability relating to multi-cell DCI scheduling to a base station. Also, implementations of this disclosure provide mechanisms for a UE to determine the maximum number of BD/CCEs for multi-cell DCI scheduling. With one or more features describe below, the UE and the base station can properly perform multi-cell DCI scheduling for PDSCH/PUSCH communications without significant increase of the UE complexity.

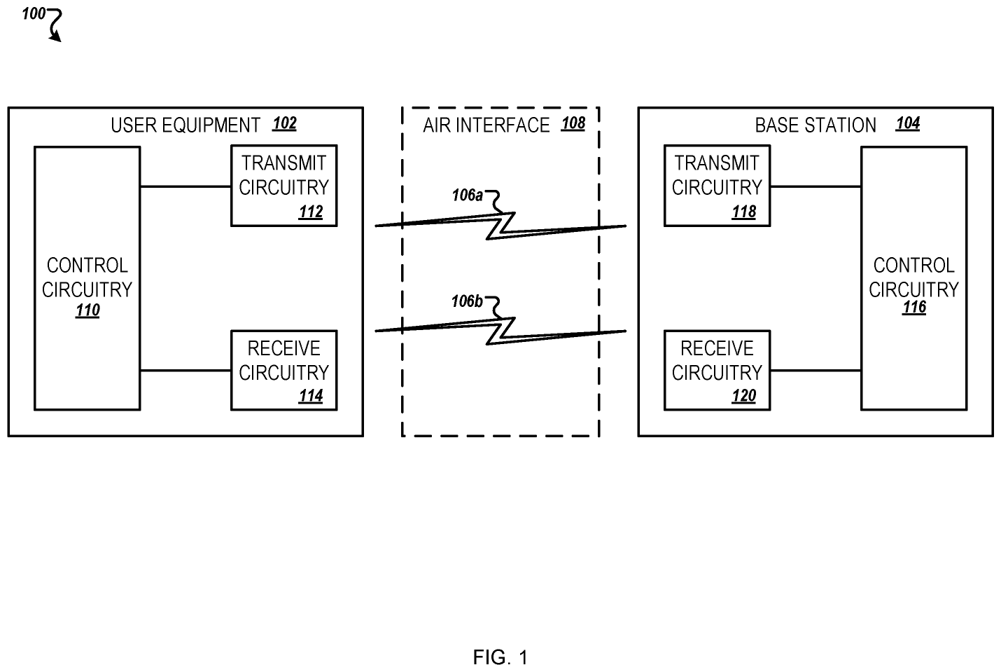

FIG. 1 illustrates a wireless network 100, according to some implementations. The wireless network 100 includes a UE 102 and a base station 104 connected via one or more channels 106A, 106B across an air interface 108. The UE 102 and base station 104 communicate using a system that supports controls for managing the access of the UE 102 to a network via the base station 104.

In some implementations, the wireless network 100 may be a Non-Standalone (NSA) network that incorporates LTE and 5G NR communication standards as defined by the 3GPP technical specifications. For example, the wireless network 100 may be a E-UTRA (Evolved Universal Terrestrial Radio Access)-NR Dual Connectivity (EN-DC) network, or a NR-EUTRA Dual Connectivity (NE-DC) network. However, the wireless network 100 may also be a Standalone (SA) network that incorporates only 5G NR. Furthermore, other types of communication standards are possible, including future 3GPP systems (e.g., Sixth Generation (6G)) systems, Institute of Electrical and Electronics Engineers (IEEE) 802.11 technology (e.g., IEEE 802.11a; IEEE 802.11b; IEEE 802.11g; IEEE 802.11-2007; IEEE 802.11n; IEEE 802.11-2012; IEEE 802.11ac; or other present or future developed IEEE 802.11 technologies), IEEE 802.16 protocols (e.g., WMAN, WiMAX, etc.), or the like. While aspects may be described herein using terminology commonly associated with 5G NR, aspects of the present disclosure can be applied to other systems, such as 3G, 4G, and/or systems subsequent to 5G (e.g., 6G).

In the wireless network 100, the UE 102 and any other UE in the system may be, for example, laptop computers, smartphones, tablet computers, machine-type devices such as smart meters or specialized devices for healthcare, intelligent transportation systems, or any other wireless devices with or without a user interface. In network 100, the base station 104 provides the UE 102 network connectivity to a broader network (not shown). This UE 102 connectivity is provided via the air interface 108 in a base station service area provided by the base station 104. In some implementations, such a broader network may be a wide area network operated by a cellular network provider, or may be the Internet. Each base station service area associated with the base station 104 is supported by antennas integrated with the base station 104. The service areas are divided into a number of sectors associated with certain antennas. Such sectors may be physically associated with fixed antennas or may be assigned to a physical area with tunable antennas or antenna settings adjustable in a beamforming process used to direct a signal to a particular sector.

The UE 102 includes control circuitry 110 coupled with transmit circuitry 112 and receive circuitry 114. The transmit circuitry 112 and receive circuitry 114 may each be coupled with one or more antennas. The control circuitry 110 may include various combinations of application-specific circuitry and baseband circuitry. The transmit circuitry 112 and receive circuitry 114 may be adapted to transmit and receive data, respectively, and may include radio frequency (RF) circuitry or front-end module (FEM) circuitry.

In various implementations, aspects of the transmit circuitry 112, receive circuitry 114, and control circuitry 110 may be integrated in various ways to implement the operations described herein. The control circuitry 110 may be adapted or configured to perform various operations such as those described elsewhere in this disclosure related to a UE. For instance, the control circuitry 110 can determine the capability of the UE 102 relating to multi-cell DCI scheduling and count BD/CCE limits for each monitored cell.

The transmit circuitry 112 can perform various operations described in this specification. For example, the transmit circuitry 112 can transmit a message to report the capability of the UE 102 to the base station 104. Additionally, the transmit circuitry 112 may transmit a plurality of multiplexed uplink physical channels. The plurality of uplink physical channels may be multiplexed according to time division multiplexing (TDM) or frequency division multiplexing (FDM) along with carrier aggregation. The transmit circuitry 112 may be configured to receive block data from the control circuitry 110 for transmission across the air interface 108.

The receive circuitry 114 can perform various operations described in this specification. For instance, the receive circuitry 114 can receive DCI that schedules one or more cells via the air interface 108. Additionally, the receive circuitry 114 may receive a plurality of multiplexed downlink physical channels from the air interface 108 and relay the physical channels to the control circuitry 110. The plurality of downlink physical channels may be multiplexed according to TDM or FDM along with carrier aggregation. The transmit circuitry 112 and the receive circuitry 114 may transmit and receive both control data and content data (e.g., messages, images, video, etc.) structured within data blocks that are carried by the physical channels.

FIG. 1 also illustrates the base station 104. In implementations, the base station 104 may be an NG radio access network (RAN) or a 5G RAN, an E-UTRAN, a non-terrestrial cell, or a legacy RAN, such as a UTRAN or GERAN. As used herein, the term “NG RAN” or the like may refer to the base station 104 that operates in an NR or 5G wireless network 100, and the term “E-UTRAN” or the like may refer to a base station 104 that operates in an LTE or 4G wireless network 100. The UE 102 utilizes connections (or channels) 106A, 106B, each of which includes a physical communications interface or layer.

The base station 104 circuitry may include control circuitry 116 coupled with transmit circuitry 118 and receive circuitry 120. The transmit circuitry 118 and receive circuitry 120 may each be coupled with one or more antennas that may be used to enable communications via the air interface 108. The transmit circuitry 118 and receive circuitry 120 may be adapted to transmit and receive data, respectively, to any UE connected to the base station 104. The transmit circuitry 118 may transmit downlink physical channels includes of a plurality of downlink subframes. The receive circuitry 120 may receive a plurality of uplink physical channels from various UEs, including the UE 102.

In FIG. 1, the one or more channels 106A, 106B are illustrated as an air interface to enable communicative coupling, and can be consistent with cellular communications protocols, such as a GSM protocol, a CDMA network protocol, a UMTS protocol, a 3GPP LTE protocol, an Advanced long term evolution (LTE-A) protocol, a LTE-based access to unlicensed spectrum (LTE-U), a 5G protocol, a NR protocol, an NR-based access to unlicensed spectrum (NR-U) protocol, and/or any of the other communications protocols discussed herein. In implementations, the UE 102 may directly exchange communication data via a ProSe interface. The ProSe interface may alternatively be referred to as a sidelink (SL) interface and may include one or more logical channels, including but not limited to a Physical Sidelink Control Channel (PSCCH), a Physical Sidelink Control Channel (PSCCH), a Physical Sidelink Discovery Channel (PSDCH), and a Physical Sidelink Broadcast Channel (PSBCH).

As discussed above, UE 102 can be configured to communicate with base station 104 in multiple cells. These cells can include one or more groups, and each group of cells can be scheduled by a multi-cell DCI signal. As an example, UE 102 is capable of being configured with 8 cells, CC0-CC7. A maximum of 5 cells, e.g., CC0-CC4, are schedulable by a multi-cell DCI signal, while the remaining cells, CC5-CC7, are schedulable by another multi-cell DCI signal. In such a case, the 8 cells include 2 groups: {CC0, CC1, CC2, CC3, CC4} and {CC5, CC6, and CC7}. The first group has 5 cells and the second group has 3 cells.

In some implementations, UE 102 is configured to report to base station 104 capability of supporting groups of cells in multi-cell DCI scheduling. For example, UE 102 can report the maximum number of groups it can support. Additionally or alternatively, UE 102 can report the maximum number of cells in each group it can support.

The determining and reporting of (a) the maximum number of cells in a group, and/or (b) the maximum number of groups, can be with different levels of granularity (e.g., level of details). Example levels of granularity include (i) per UE, (ii) for each frequency range (FR), (iii) for each band combination, and (iv) for each band in a band combination.

In the example above where 8 cells are scheduled in two groups by two multi-cell DCI signals, assuming 5 is the maximum number of cells UE 102 can support in each group, UE 102 can report 5 to base station 104 as corresponding to capability (a). Similarly, assuming UE 102 cannot support 3 or more groups of cells, UE 102 can report 2 to base station 104 as corresponding to capability (b). The reporting of these capabilities can be considered with a granularity of (i) per UE.

In some implementations, UE 102 further determines and reports these capabilities for each FR. For example, UE 102 may support communication in a first FR (FR1) and a second FR (FR2). UE 102 can determine and report capabilities (a) and/or (b) separately for communication in FR1 and communication in FR1. The reporting of these capabilities can be considered with a granularity of (ii) for each FR.

In some implementations, UE 102 further determines and reports these capabilities for each band combination. For example, UE 102 may support communication using a first band combination and a second band combination. UE 102 can determine and report capabilities (a) and/or (b) separately for communication using the first band combination and communication using the second band combination. The reporting of these capabilities can be considered with a granularity of (iii) for each band combination.

In some implementations, UE 102 further determines and reports these capabilities for each band in a band combination. For example, UE 102 may support communication using a band combination of a first band and a second band. UE 102 can determine and report capabilities (a) and/or (b) separately for communication using the first band and communication using the second band. The reporting of these capabilities can be considered with a granularity of (iv) for each band in a band combination.

The above granularity levels are examples only. The capability reporting can be with other granularity levels in other implementations. Capabilities (a) and (b) can be reported together or separately reported for a given granularity level.

As discussed above, the cell in which the DCI signal is transmitted is referred to as the scheduling cell. For multi-cell DCI scheduling, the scheduling cell may or may not be included in the group of schedulable cells. For example, the scheduling cell of the group {CC0, CC1, CC2, CC3, CC4} may be CC0, which is within the group. Alternatively, the scheduling cell of the group {CC0, CC1, CC2, CC3, CC4} may be CC5, which is not within the group. UE 102 may or may not have the capability to support either or both of the two alternatives.

In some implementations, UE 102 is configured to report whether it supports (c) the scheduling cell being one of the multiple cells schedulable by a multi-cell DCI signal and/or (d) the scheduling cell not being one of the multiple cells schedulable by a multi-cell DCI signal.

In some implementations, UE 102 is configured to report capabilities of multi-cell DCI scheduling with SCSs considered. For example, UE 102 can report whether it supports (e) the schedulable cells having the same SCS and/or (f) the schedulable cells having different SCSs. In the event UE 102 supports (e), UE 102 can further report whether it supports (g) the schedulable cells and the scheduling cell have the same SCS. Capabilities (e)-(g) can further be separately reported according to UE 102's capabilities (c) and (d).

The above UE capabilities are examples only. With one or more UE capabilities reported to the base station 104, base station 104 can accurately determine the resources to use when scheduling cells with multi-cell DCI. Accordingly, the multi-cell scheduling can be effectively performed between UE 102 and base station 104, thereby increasing flexibility and efficiency of communication.

As discussed above, when a UE monitors multiple cells for potential DCI, the UE may want to count the BD/CCEs for each cell schedulable by either multi-cell DCI or single-cell DCI. In addition, because each cell corresponds to an SCS, the UE may want to determine an upper limit of BD/CCEs for each SCS. Described below are various example implementations in which the UE can determine the upper limit. In the below implementations where a group of cells are schedulable by multi-cell DCI in a scheduling cell, the BD/CCEs of the group of schedulable cells are all counted towards the scheduling cell. Correspondingly, the BD/CCEs of each of the schedulable cells are not separately counted.

In some implementations, despite the BD/CCEs of the schedulable cells are counted towards the scheduling cell, the limit of BD/CCEs of the scheduling cell is not increased from the limit provided for a single cell. For example, assume the scheduling cell has an SCS of 30 kHz and can schedule a group of 3 cells. The BD limit of the scheduling cell is not increased from 36 (which equals the BD limit per cell per slot for SCS of 30 kHz), even if the BDs of the 3 co-schedulable cells are counted towards the scheduling cell. This mechanism, while simple to implement, may put limit on the UE's monitoring capability for other types of scheduling.

In some implementations, the limit of BD/CCEs of the scheduling cell is increased from the limit provided for a single cell. The increase can be based on a scaling factor α, which accounts for the limit of BD/CCEs for both multi-cell DCI scheduling and single-cell DCI scheduling. For example, assume a scheduling cell has an SCS of 30 kHz and can schedule a group of 3 cells with a multi-cell DCI, and assume the same scheduling cell can also cross-schedule another 1 cell with a single-cell DCI. When α=3, the limit of BDs of the scheduling cell equals 3×36=108. This indicates that, counting altogether the BDs from the 3 cells co-schedulable by the multi-cell DCI and from the 1 cell cross-schedulable by the single-cell DCI, the scheduling cell cannot support more than 108 BDs.

An alternative to α is a scaling factor β, which accounts for the limit of BD/CCEs for multi-cell DCI scheduling only. To explain, in an example with the same assumptions as the previous example, when β=3, the limit of BDs of the scheduling cell equals 3×36=108. This indicates that, counting the BDs from the 3 cells co-schedulable by the multi-cell DCI only, the scheduling cell cannot support more than 108 BDs. Whether the UE uses α or β as the scaling factor can depend on the specific UE implementation.

The scaling factor α or β can be determined in a variety of ways. In some implementations, the scaling factor equals a pre-defined number. In some implementations, the scaling factor equals the number of cells schedulable by a multi-cell DCI (3 in the two examples above). In some implementations, in particular where the scheduling cell is also self-schedulable by a single-cell DCI, the scaling factor equals the number of cells schedulable by a multi-cell DCI plus 1.

In some implementations, the scaling factor is determined based on a capability of the UE, and the UE can report its capability of supporting the scaling factor to a base station. For example, the UE can report the value of α or β it supports to the base station.

In some implementations, the actual scaling factor is determined based on a combination of the reported UE capability and the number of co-schedulable cells. For example, while the UE reports α=3 to the base station, the actual scaling factor for the determining the BD/CCE limit of the scheduling cell can be determined as min(α, the number of co-schedulable cells).

While the BD/CCEs of cells schedulable by multi-cell DCI are counted towards the scheduling cell, a limit of BD/CCEs can still be imposed for each of the schedulable cells based on their corresponding SCS. For example, a schedulable cell with an SCS of 30 kHz can have no more than 36 BDs, even though all these BDs are counted as if they are provided for the scheduling cell.

In addition to determining the limit for the scheduling cell and the schedulable cells, the UE in some implementations determines an upper limit of BD/CCEs for each SCS. This determination involves determining an effective number of cells corresponding to each SCS and specifically involves separate determination for the scheduling cell and for the schedulable cells.

In some implementations, the scheduling cell is counted as one or more cells with its actual SCS. That is, a scheduling cell actually having an SCS of 30 kHz is counted as one or more cells with an effective SCS of 30 kHz for the purpose of the above determination.

By contrast, the schedulable cells may or may not be counted as cells whose effective SCSs are the same as their actual SCSs. As a first example, in some implementations, the effective SCS of the schedulable cell is determined as equal to its actual SCS. As a second example, in some implementations, the effective SCS of the schedulable cell is determined as equal to the actual SCS of the scheduling cell, regardless of the actual SCS of the schedulable cell. As a third example, in some implementations, the effective SCS of the schedulable cell is determined as equal to the actual SCS of a cross-scheduling cell that cross-schedules the schedulable cell with a single-cell DCI, regardless of the actual SCSs of the schedulable cell and the multi-scheduling cell. As a fourth example, in some implementations, the schedulable cell is not counted as corresponding to any SCS for the purpose of the above determination.

The four examples given above may be suitable for different cases. In particular, the second and the fourth examples may be suitable if the schedulable cell cannot be self-scheduled or cross-scheduled by any cells other than the scheduling cell. In this case, all BD/CCEs of the schedulable cell are counted towards the BD/CCE limit of the scheduling cell. There is no need to allocate any BD/CCEs for the schedulable cell.

The first example may be suitable if the schedulable cell can be self-scheduled by a single-cell DCI. In this case, the BD/CCEs for multi-cell scheduling may be counted towards the BD/CCE limits of the scheduling cell, while the BD/CCEs for self-scheduling may be counted towards the BD/CCE limit of the schedulable cell.

The third example may be suitable if the schedulable cell can be cross-scheduled by a single-cell DCI from a cell other than the scheduling cell of the multi-cell DCI. In this case, the BD/CCEs for multi-cell scheduling may be counted towards the BD/CCE limits of the multi-scheduling cell, while the BD/CCEs for cross-scheduling may be counted towards the BD/CCE limit of the cross-scheduling cell.

Apart from determining the cells' corresponding (effective) SCSs, the UE in some implementations determines an effective number by which a cell is counted. Specifically, for the purpose of determining the upper limit of BD/CCEs for each SCS, the scheduling cell may be effectively counted as one or more cells.

In some implementations, the scheduling cell is effectively counted as one cell.

In some implementations, the scheduling cell is effectively counted as K1 cells, where K1 denotes the number of cells schedulable by the multi-cell DCI in the scheduling cell. In some implementations, in particular where the UE is configured with capability (d), the scheduling cell is effectively counted as K1+1 cells.

In some implementations, the scheduling cell is effectively counted as K2 cells, where K2 denotes the number of cells schedulable either by the multi-cell DCI, by a single-cell DCI in the scheduling cell, or by both.

In some implementations, the scheduling cell is effectively counted as α cells, where α denotes the scaling factor.

In some implementations, the scheduling cell is effectively counted as min(K1, α) cells or min(K2, α) cells.

Depending on how the scheduling cell is effectively counted, each schedulable cell may be effectively counted as one or zero cell for its effective SCS. With the effective number of all cells determined per SCS, the UE can further determine an effective total number of cells across all SCSs. The effective total number of cells may or may not equal the actual total number of cells.

The UE can determine a BD/CCE limit for the scheduling cell by multiplying the effective number counted for the scheduling cell with the BD/CCE per-cell limit for the corresponding SCS. The resultant number may be larger than the BD/CCE limit for all cells corresponding to the SCS. As such, some implementations impose an upper bound over the BD/CCE limit calculated based on the effective number of the scheduling cell.

In some implementations, the UE imposes an upper bound as (the effective number of all cells for the SCS×the BD/CCE per-cell limit for the SCS).

In some implementations, the UE imposes an upper bound only when the effective total number of cells across all SCSs exceeds the UE's capability of monitoring cells. The upper bound can be calculated using a pre-defined formula. The UE may report its capability of monitoring cells to a base station.

The approaches for determining the effective SCS of the schedulable cells, counting the effective number of cells for the scheduling cell, counting the effective number of cells for the schedulable cells, or imposing an upper bound, can be combined to arrive at numerous implementations. Described below are a few examples for illustrating how the BD/CCE limits can be determined in different scenarios.

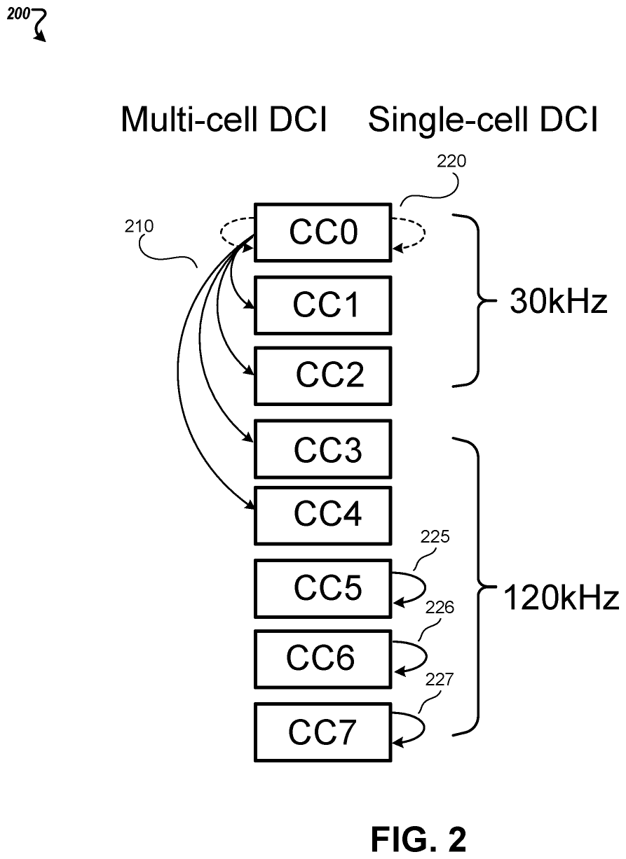

FIGS. 2-4 each illustrate a scenario (200, 300, 400) where a plurality of cells are scheduled by various DCI signals, according to some implementations. These scenarios are described with the following assumptions: The UE (such as UE 102) is capable of communicating with the base station (such as base station 104) using 8 cells (CC0-CC7); CC0 is the scheduling cell that can schedule CC1-CC4 or CC0-CC4 with a multi-cell DCI signal (210, 310, 410); CC5-CC7 are only self-schedulable with a single-cell DCI signal for each (225-227, 325-327, 425-427); CC0 may or may not be self-schedulable with a single-cell DCI signal (220, 320, 420); CC0-CC2 use 30 kHz of SCS (numerology μ=1, per-cell limit=36) while CC3-CC7 use 120 kHz of SCS (numerology μ=3, per-cell limit=20); The UE reports the scaling factor α=3 for CC0. In addition, the below description covers two cases of UE's capability

$${N}_{cells}^{c a p}$$

of monitoring cells: Case A:

$${N}_{cells}^{c a p} = 8 ;$$

### Case B:

$${N}_{cells}^{c a p} = 5 .$$

For brevity, only BD limits are calculated, while CCE limits can be calculated analogously.

In scenario 200 of FIG. 2, CC1-CC4 are schedulable only by multi-cell DCI signal 210. Two possible approaches for determining the BD/CCE limit for the scheduling cell CC0 and the BD/CCE limit for each SCS are described.

According to a first approach, CC0 is counted as a single cell with 30 kHz SCS. Each of schedulable cells CC1-CC4 is counted as a single cell, but the BD/CCEs of CC1-CC4 associated with multi-cell DCI signal 210 are counted towards CC0. The effective SCSs of CC1-CC4 are determined as all equal to the SCS of CC0 (30 KHz SCS) even though the actual SCSs of CC3 and CC4 are equal to 120 kHz. As such, there are effectively 5 cells (CC0-CC4) counted for SCS=30 kHz and 3 cells (CC5-CC7) counted for SCS=120 kHz. The effective number of cells for SCS=30 kHz is thus

$${N}_{cells}^{μ = 1} = 5 ,$$

while the effective number of cells for SCS=120 kHz is thus

$${N}_{cells}^{μ = 3} = 3 .$$

Each cell is applied with its own BD limit. For CC0, assume the actual scaling factor equals min(α, the number of co-schedulable cells). Whether multi-cell DCI signal 210 can schedule CC0 or not, the actual scaling factor can be determined as min(α, 5)=min(α, 4)=3. Thus, the BD limit for CC0 is determined as 3×36=108. For CC1-CC4, the BDs of these cells are all counted towards CC0, so no limits are needed for CC1-CC4. For CC5-CC7, each cell determines a BD limit according to its actual SCS=120 kHz. The BD limit for each of CC5-CC7 is thus 20.

The BD limit for each SCS can also be determined. First, the effective total number of cells across all SCSs,

$${\sum }_{j} {N}_{cells}^{j} ,$$

can be determined as equal to

$${N}_{cells}^{μ = 1} + {N}_{cells}^{μ = 3} = 5 + 3 = 8. {\sum }_{j} {N}_{cells}^{j}$$

is then compared with the UE's capability

$${N}_{cells}^{c a p} .$$

In case A,

$${\sum }_{j} {N}_{cells}^{j} \leq {N}_{cells}^{c a p} = 8 .$$

This means the effective total number of cells across all SCSs is within the UE's capability of monitoring. In case B,

$${\sum }_{j} {N}_{cells}^{j} > {N}_{cells}^{c a p} = 5 .$$

This means the effective total number of cells across all SCSs is beyond the UE's capability of monitoring.

For case A, because the UE is capable of monitoring the effective number of cells in each SCS, each cell simply applies the BD limit according to its SCS. That is, the BD limit for CC0 is 108, and the BD limit for each of CC5-CC7 is 20.

For case B, because the UE is incapable of monitoring all of the effective number of cells in all SCSs, an upper bound is applied according to a formula. Specifically, for SCS of 30 kHz (numerology μ=1), the upper bound is determined as

$${M}_{P D C C H}^{total , μ = 1} = {N}_{cells}^{c a p} \times {M}_{P D C C H}^{max , slot , μ = 1} \times {N}_{cells}^{μ = 1} / {\sum }_{j} {N}_{cells}^{j} = 5 \times 36 \times 5 / 8 = 112 ,$$

and for SCS of 120 kHz (numerology μ=3), the upper bound is determined as

$${M}_{P D C C H}^{total , μ = 3} = {N}_{cells}^{c a p} \times {M}_{P D C C H}^{max , slot , μ = 3} \times {N}_{cells}^{μ = 3} / {\sum }_{j} {N}_{cells}^{j} = 5 \times 20 \times 3 / 8 = 37 .$$

In the above equations,

$${M}_{P D C C H}^{total , μ = 1}$$

denotes the total number of BDs in SCS of 30 kHz that can be monitored, and

$${M}_{P D C C H}^{total , μ = 3}$$

denotes the total number of BDs in SCS of 120 KHz that can be monitored.

$${M}_{P D C C H}^{max , slot , μ = 1}$$

denotes the maximum number of BDs per cell per slot for SCS of 30 kHz, and

$${M}_{P D C C H}^{max , slot , μ = 3}$$

denotes the maximum number of BDs per cell per slot for SCS of 120 kHz.

With the upper bound for SCS of 30 kHz applied, the total number of BDs on CC0 should not exceed min(112, 108)=108. Similarly, with the upper bound for SCS of 120 kHz applied, the total number of BDs on CC5-CC7 altogether should not exceed 37.

Keeping with scenario 200, according to a second approach, CC0 is counted as min(α, the number of co-schedulable cells)=3 cells with 30 kHz SCS. With this approach, co-schedulable cells CC1-CC4 are counted as zero cells (i.e., not separately counted) and do not need BD/CCEs limits. As such, there are effectively 3 cells (all from CC0) counted for SCS=30 kHz and 3 cells (CC5-CC7) counted for SCS=120 kHz. The effective number of cells for SCS=30 kHz is thus

$${N}_{cells}^{μ = 1} = 3 ,$$

while the effective number of cells for SCS=120 KHz is

$${N}_{cells}^{μ = 3} = 3 .$$

Similar to the first approach, the BD limit for CC0 is determined as 3×36=108, and the BD limit for each of CC5-CC7 is 20.

It can be determined that

$${\sum }_{j} {N}_{c e l l s}^{j} = 3 + 3 = 6$$

with the second approach. For case A, the per-SCS BD limits can be determined as 108 for CC0 and 20 for each of CC5-CC7. For case B,

$${M}_{P D C C H}^{total , μ = 1} and {M}_{P D C C H}^{total , μ = 3}$$

can be determined with the same formulae as 90 and 50, respectively. Thus, the total number of BDs on CC0 should not exceed min(90, 108)=90, and the total number of BDs on CC5-CC7 altogether should not exceed 50.

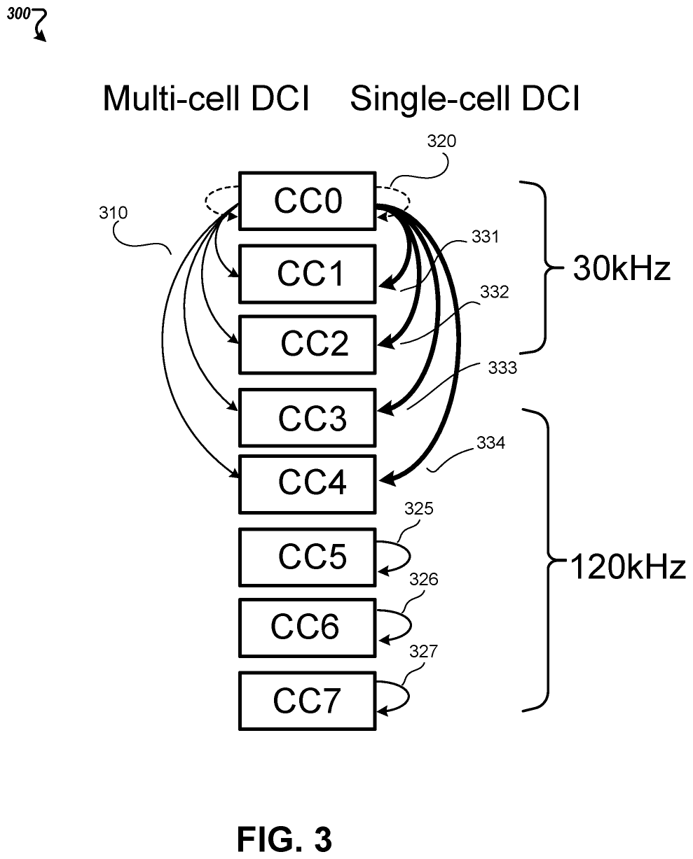

In scenario 300 of FIG. 3, CC1-CC4 are schedulable both by multi-cell DCI signal 210 in CC0 and by a corresponding single-cell DCI signal 331-334 in CC0. Two possible approaches for determining the BD/CCE limit for the scheduling cell CC0 and the BD/CCE limit for each SCS are described.

According to a first approach, CC0 is counted as min(α, the number of co-schedulable cells)=3 cells with 30 kHz SCS. Each of cells CC1-CC4 is counted as a single cell. The effective SCSs of CC1-CC4 are determined as all equal to the SCS of CC0 (30 KHz SCS) because of single-cell DCI 331-334 in CC0. As such, there are effectively 7 cells (CC0 counted as 3, CC1-CC4 each counted as 1) counted for SCS=30 kHz and 3 cells (CC5-CC7) counted for SCS=120 kHz. The effective number of cells for SCS=30 kHz is thus

$${N}_{cells}^{μ = 1} = 7 ,$$

while the effective number of cells for SCS=120 kHz is

$${N}_{cells}^{μ = 3} = 3 .$$

Each of cells CC1-CC4 can have up to 36 BDs for single-cell DCI scheduling from CC0 and these BDs are counted towards CC0. Each of cells CC5-CC7 can have up to 20 BDs for self-scheduling. Assuming the actual scaling factor for CC0 equals min(α, the number of co-schedulable cells)=3, CC0 can have up to 3×36=108 BDs for multi-cell DCI scheduling.

For case A where

$${N}_{cells}^{c a p} = 8 < {N}_{cells}^{μ = 1} + {N}_{cells}^{μ = 3} = 7 + 3 = 10 ,$$

applying the same formulae as in scenario 200, it can be determined that

$${M}_{P D C C H}^{total , μ = 1} = 201 and {M}_{P D C C H}^{total , μ = 3} = 48 .$$

Thus, the total number of BDs on CC0 (including those for multi-cell DCI scheduling and those for single-cell DCI cross-scheduling) should not exceed 201, and the total number of BDs on CC5-CC7 altogether should not exceed 48. For case B, applying the same formulae as in scenario 200, the calculation is omitted for brevity.

Keeping with scenario 300, according to a second approach, CC0 is counted as a single cell with 30 kHz SCS. Each of cells CC1-CC4 is counted as a single cell. The effective SCSs of CC1-CC4 are determined as all equal to the SCS of CC0 (30 KHz SCS) because of single-cell DCI 331-334 in CC0. Accordingly,

$${N}_{c e l l s}^{μ = 1} = 5 and {N}_{c e l l s}^{μ = 3} = 3 .$$

Similar to the first approach and also assuming the actual scaling factor equals min(α, the number of co-schedulable cells), the BD limit for CC0 is determined as 3×36=108. Each of cells CC1-CC4 can have up to 36 BDs for single-cell DCI scheduling from CC0 and these BDs are counted towards CC0. Each of cells CC5-CC7 can have up to 20 BDs for self-scheduling.

For case A, even though

$${N}_{cells}^{c a p} = 8 \geq {N}_{cells}^{μ = 1} + {N}_{cells}^{μ = 3} = 5 + 3 = 8 ,$$

an upper bound can be applied for CC0-CC4 (cells with SCS of 30 kHz). For example, the upper bound for SCS of 30 kHz can be

$${N}_{cells}^{μ = 1} \times 36 = 180.$$

Alternatively, the upper bound for SCS of 30 kHz can be

$${M}_{P D C C H}^{total , μ = 1} = {N}_{c e l l s}^{c a p} \times {M}_{P D C C H}^{max , slot , μ = 1} \times {N}_{cells}^{μ = 1} / {\sum }_{j} {N}_{cells}^{j} = 180 .$$

For case B, applying the same formulae as in scenario 200, it can be determined that

$${M}_{P D C C H}^{total , μ = 1} = 112 and {M}_{P D C C H}^{total , μ = 3} = 37.$$

Thus, the total number of BDs on CC0 (including those for multi-cell DCI scheduling and those for single-cell DCI cross-scheduling) should not exceed min(112, 3×36)=108. Similarly, the total number of BDs on CC5-CC7 altogether should not exceed 37.

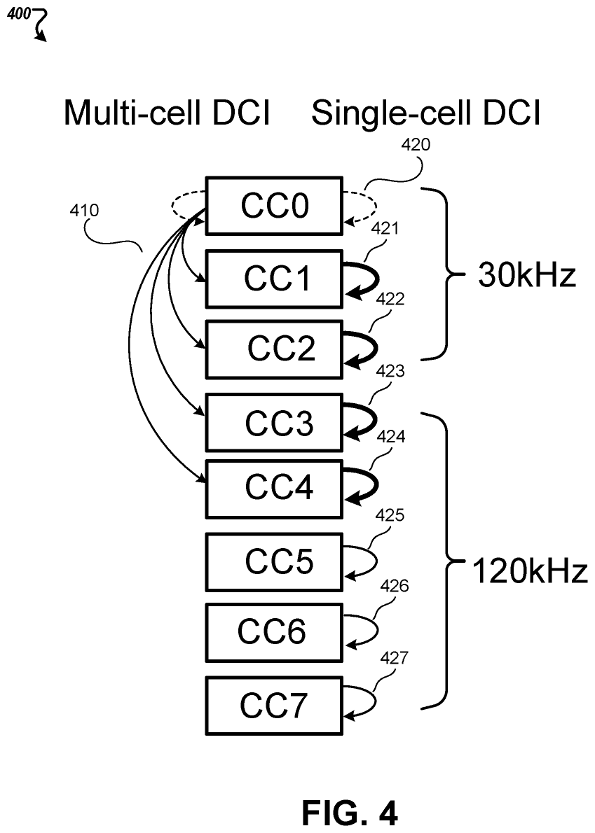

In scenario 400 of FIG. 4, CC1-CC4 are schedulable by multi-cell DCI signal 210 in CC0 and self-schedulable by a corresponding DCI signal 421-424. Two possible approaches for determining the BD/CCE limit for the scheduling cell CC0 and the BD/CCE limit for each SCS are described.

According to a first approach of scenario 400, CC0 is counted as min(α, the number of co-schedulable cells)=3 cells with 30 kHz SCS. Each of schedulable cells CC1-CC4 is counted as a single cell according to its actual SCS to account for self-scheduling. That is, CC1-CC2 are counted as two cells with 30 kHz SCS while CC3-CC4 are counted as two cells with 120 kHz SCS. The effective number of cells for SCS-30 kHz is thus

$${N}_{cells}^{μ = 1} = 5 ,$$

while the effective number of cells for SCS=120 kHz is

$${N}_{cells}^{μ = 3} = 5 .$$

CC1-CC2 can each nave up to 36 BDs for self-scheduling. CC3-CC7 can each have up to 20 BDs for self-scheduling. For CC0, assuming the actual scaling factor equals min(α, the number of co-schedulable cells)=3, the BD limit for CC0 is determined as 3×36=108.

For case A, it can be further determined that

$${N}_{cells}^{μ = 1} + {N}_{cells}^{μ = 3} = 5 + 5 = 10 > {N}_{cells}^{c a p} = 8 .$$

Applying the same formulae as in scenario 200, it can be determined that

$${M}_{P D C C H}^{total , μ = 1} = 144 and {M}_{P D C C H}^{total , μ = 3} = 80 .$$

Thus, the total number of BDs on CC0-CC2 (including those for multi-cell DCI scheduling and those for self-scheduling) should not exceed 144, and the total number of BDs on CC3-CC7 altogether should not exceed 80. For case B, the calculation is omitted for brevity.

According to a second approach of scenario 400, CC0 is counted as a single cell with 30 kHz SCS. Each of schedulable cells CC1-CC4 is counted as a single cell according to its actual SCS to account for self-scheduling. That is, CC1-CC2 are counted as two cells with 30 kHz SCS while CC3-CC4 are counted as two cells with 120 kHz SCS. The effective number of cells for SCS=30 kHz is thus

$${N}_{cells}^{μ = 1} = 3 ,$$

while the effective number of cells for SCS=120 kHz is

$${N}_{cells}^{μ = 3} = 5 .$$

CC1-CC2 can each have up to 36 BDs for self-scheduling. CC3-CC7 can each have up to 20 BDs for self-scheduling. For CC0, assuming the actual scaling factor equals min(α, the number of co-schedulable cells)=3, the BD limit for CC0 is determined as 3×36=108.

For case A, even though

$${N}_{cells}^{c a p} = 8 = {N}_{cells}^{μ = 1} + {N}_{cells}^{μ = 3} = 5 + 3 ,$$

an upper bound can be applied for CC0-CC2 (cells with SCS of 30 kHz). For example, the upper bound for SCS of 30 kHz can be

$${N}_{c e l l s}^{μ = 1} \times 36 = 108 .$$

Alternatively, the upper bound for SCS of 30 kHz can be

$${M}_{P D C C H}^{total , μ = 1} = {N}_{c e l l s}^{c a p} \times {M}_{P D C C H}^{max , slot , μ = 1} \times {N}_{cells}^{μ = 1} / {\sum }_{j} {N}_{cells}^{j} = 108.$$

For case B, applying the same formulae as in scenario 200, it can be determined that

$${M}_{P D C C H}^{total , μ = 1} = 67 and {M}_{P D C C H}^{total , μ = 3} = 62 .$$

Thus, the total number of BDs on CC0-CC2 (including those for multi-cell DCI scheduling and those for self-scheduling) should not exceed min(67, 3×36)=67, and the total number of BDs on CC3-CC7 altogether should not exceed 62.

Above described are only a few examples among many for determining BD/CCE limits for a UE with multi-cell DCI scheduling. The UE can determine which approaches to implement or to use according to the specific scenario and can be configured to switch among different approaches. Implementations of this disclosure this provide great flexibility to communications systems that use multi-cell DCI scheduling. Thanks to such flexibility, it is possible to keep the UE complexity reasonably low even when the UE needs to monitor a large number of cells.

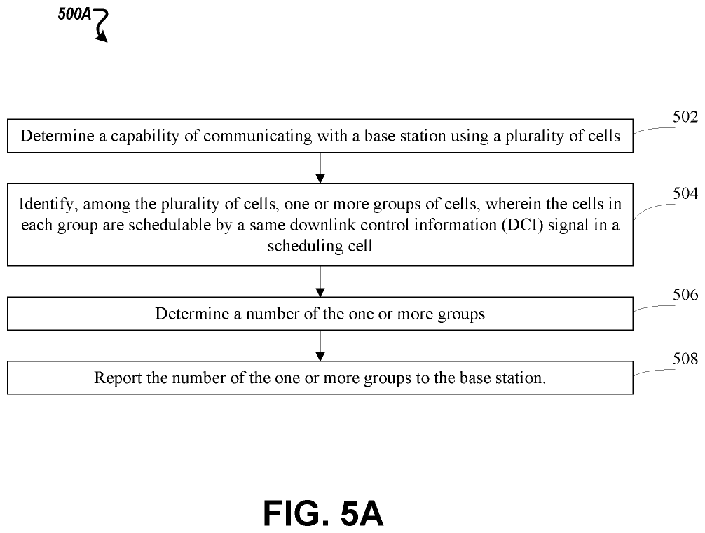

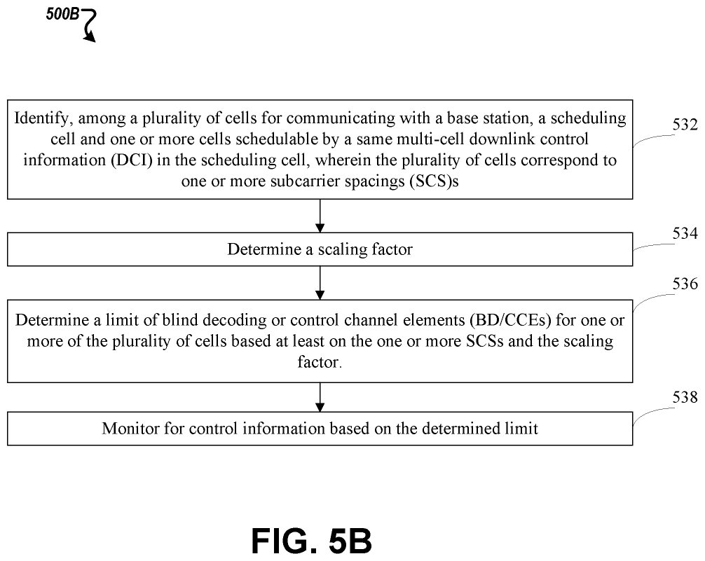

FIG. 5A illustrates a flowchart of an example method 500A, according to some implementations. For clarity of presentation, the description that follows generally describes method 500A in the context of the other figures in this description. For example, method 500A can be performed by UE 102 of FIG. 1. It will be understood that method 500A can be performed, for example, by any suitable system, environment, software, hardware, or a combination of systems, environments, software, and hardware, as appropriate. In some implementations, various steps of method 500A can be run in parallel, in combination, in loops, or in any order.

At 502, method 500A involves determining a capability of communicating with a base station, such as base station 104 in FIG. 1, using a plurality of cells, such as CC0-CC7 illustrated in FIGS. 2-4.

At 504, method 500A involves identifying, among the plurality of cells, one or more groups of cells, wherein the cells in each group are schedulable by a same DCI signal in a scheduling cell. The one or more groups of cells can be, e.g., CC0-CC4 illustrated in FIGS. 2-4, and the DCI signal can be, e.g., DCI signal 210.

At 506, method 500A involves determining a number of the one or more groups. In the examples of FIGS. 2-4, assuming no groups other than {CC0, CC1, CC2, CC3, CC4} can be supported by the UE, the number is determined to be 1.

At 508, method 500A involves reporting the number of the one or more groups to the base station. The reporting can be via, e.g., air interface 108 of FIG. 1.

FIG. 5B illustrates a flowchart of an example method 500B, according to some implementations. For clarity of presentation, the description that follows generally describes method 500B in the context of the other figures in this description. For example, method 500B can be performed by UE 102 of FIG. 1. It will be understood that method 500B can be performed, for example, by any suitable system, environment, software, hardware, or a combination of systems, environments, software, and hardware, as appropriate. In some implementations, various steps of method 500B can be run in parallel, in combination, in loops, or in any order.

At 532, method 500B involves identifying, among a plurality of cells for communicating with a base station, a scheduling cell and one or more cells schedulable by a same multi-cell downlink control information (DCI) in the scheduling cell, wherein the plurality of cells correspond to one or more SCSs. The plurality of cells can be, e.g., CC0-CC7 in FIGS. 2-4, and the base station can be, e.g., base station 104 in FIG. 1. The multi-cell DCI can be, e.g., DCI signal 210 in FIGS. 2-4, and the one or more cells schedulable by the multi-cell DCI can be, e.g., CC1-CC4 in FIGS. 2-4.

At 534, method 500B involves determining a scaling factor, such as a described with reference to FIGS. 2-4.

At 536, method 500B involves determining a limit of BD/CCEs for one or more of the plurality of cells based at least on the one or more SCSs and the scaling factor. The determination of the BD/CCE limit can involve, e.g., one or more operations described above with reference to FIGS. 2-4.

At 538, method 500B involves monitoring for control information based on the determined limit. The control information can include one or more single-cell DCI or multi-cell DCI signals, such as those illustrated in FIGS. 2-4.

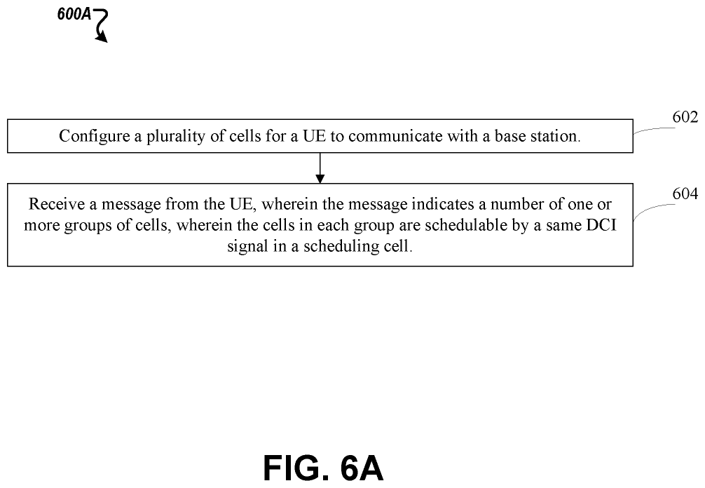

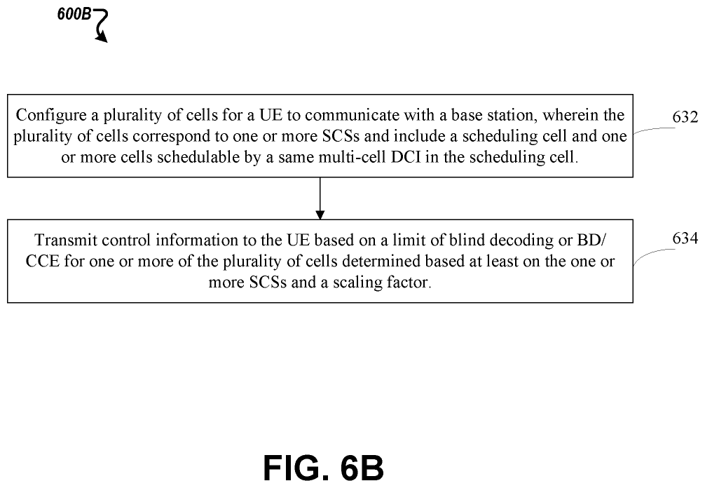

FIG. 6A illustrates a flowchart of an example method 600A, according to some implementations. For clarity of presentation, the description that follows generally describes method 600A in the context of the other figures in this description. For example, method 600A can be performed by base station 104 of FIG. 1. It will be understood that method 600A can be performed, for example, by any suitable system, environment, software, hardware, or a combination of systems, environments, software, and hardware, as appropriate. In some implementations, various steps of method 600A can be run in parallel, in combination, in loops, or in any order.

At 602, method 600A involves configuring a plurality of cells, such as CC0-CC7 illustrated in FIGS. 2-4, for a UE to communicate with a base station.

At 604, method 600A involves receiving a message from the UE. The message indicates a number of one or more groups of cells. The cells in each group are schedulable by a same DCI signal in a scheduling cell. The one or more groups of cells can be, e.g., CC0-CC4 illustrated in FIGS. 2-4, and the DCI signal can be, e.g., DCI signal 210.

FIG. 6B illustrates a flowchart of an example method 600B, according to some implementations. For clarity of presentation, the description that follows generally describes method 600B in the context of the other figures in this description. For example, method 600B can be performed by base station 104 of FIG. 1. It will be understood that method 600B can be performed, for example, by any suitable system, environment, software, hardware, or a combination of systems, environments, software, and hardware, as appropriate. In some implementations, various steps of method 600B can be run in parallel, in combination, in loops, or in any order.

At 632, method 600B involves configuring a plurality of cells, such as CC0-CC7 illustrated in FIGS. 2-4, for a UE to communicate with a base station. The plurality of cells correspond to one or more SCSs and include a scheduling cell and one or more cells schedulable by the same multi-cell DCI in the scheduling cell. The multi-cell DCI can be, e.g., DCI signal 210 in FIGS. 2-4, and the one or more cells schedulable by the multi-cell DCI can be, e.g., CC1-CC4 in FIGS. 2-4.

At 634, method 600B involves transmitting control information to the UE based on a limit of blind decoding or BD/CCE for one or more of the plurality of cells. The limit of blind decoding or BD/CCE are determined based at least on the one or more SCSs and a scaling factor. The control information can include one or more single-cell DCI or multi-cell DCI signals, such as those illustrated in FIGS. 2-4.

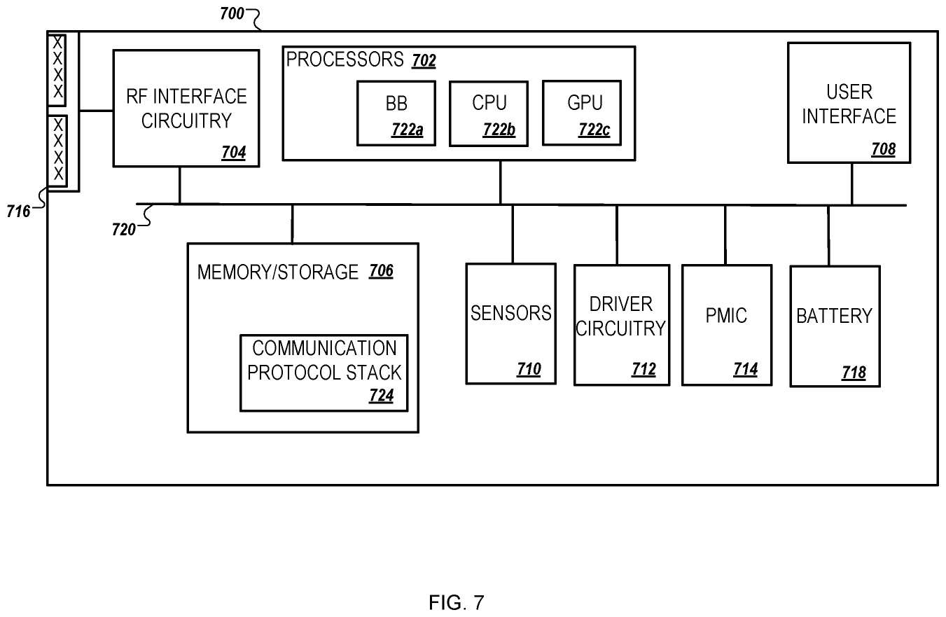

FIG. 7 illustrates a UE 700, according to some implementations. The UE 700 may be similar to and substantially interchangeable with UE 102 of FIG. 1.

The UE 700 may be any mobile or non-mobile computing device, such as, for example, mobile phones, computers, tablets, industrial wireless sensors (for example, microphones, pressure sensors, thermometers, motion sensors, accelerometers, inventory sensors, electric voltage/current meters, etc.), video devices (for example, cameras, video cameras, etc.), wearable devices (for example, a smart watch), relaxed-IoT devices.

The UE 700 may include processors 702, RF interface circuitry 704, memory/storage 706, user interface 708, sensors 710, driver circuitry 712, power management integrated circuit (PMIC) 714, antenna structure 716, and battery 718. The components of the UE 700 may be implemented as integrated circuits (ICs), portions thereof, discrete electronic devices, or other modules, logic, hardware, software, firmware, or a combination thereof. The block diagram of FIG. 7 is intended to show a high-level view of some of the components of the UE 700. However, some of the components shown may be omitted, additional components may be present, and different arrangement of the components shown may occur in other implementations.

The components of the UE 700 may be coupled with various other components over one or more interconnects 720, which may represent any type of interface, input/output, bus (local, system, or expansion), transmission line, trace, optical connection, etc. that allows various circuit components (on common or different chips or chipsets) to interact with one another.

The processors 702 may include processor circuitry such as, for example, baseband processor circuitry (BB) 722A, central processor unit circuitry (CPU) 722B, and graphics processor unit circuitry (GPU) 722C. The processors 702 may include any type of circuitry or processor circuitry that executes or otherwise operates computer-executable instructions, such as program code, software modules, or functional processes from memory/storage 706 to cause the UE 700 to perform operations as described herein. For example, the processors 702 may be configured to determine the UE capabilities described with reference to FIG. 5 and to determine the BD/CCE limits described with reference to FIG. 6.

In some implementations, the baseband processor circuitry 722A may access a communication protocol stack 724 in the memory/storage 706 to communicate over a 3GPP compatible network. In general, the baseband processor circuitry 722A may access the communication protocol stack to: perform user plane functions at a physical (PHY) layer, medium access control (MAC) layer, radio link control (RLC) layer, packet data convergence protocol (PDCP) layer, service data adaptation protocol (SDAP) layer, and PDU layer; and perform control plane functions at a PHY layer, MAC layer, RLC layer, PDCP layer, RRC layer, and a non-access stratum layer. In some implementations, the PHY layer operations may additionally/alternatively be performed by the components of the RF interface circuitry 704. The baseband processor circuitry 722A may generate or process baseband signals or waveforms that carry information in 3GPP-compatible networks. In some implementations, the waveforms for NR may be based cyclic prefix orthogonal frequency division multiplexing (OFDM) “CP-OFDM” in the uplink or downlink, and discrete Fourier transform spread OFDM “DFT-S-OFDM” in the uplink.

The memory/storage 706 may include one or more non-transitory, computer-readable media that includes instructions (for example, communication protocol stack 724) that may be executed by one or more of the processors 702 to cause the UE 700 to perform various operations described herein. The memory/storage 706 include any type of volatile or non-volatile memory that may be distributed throughout the UE 700. In some implementations, some of the memory/storage 706 may be located on the processors 702 themselves (for example, L1 and L2 cache), while other memory/storage 706 is external to the processors 702 but accessible thereto via a memory interface. The memory/storage 706 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 704 may include transceiver circuitry and radio frequency front module (RFEM) that allows the UE 700 to communicate with other devices over a radio access network. The RF interface circuitry 704 may include various elements arranged in transmit or receive paths. These elements may include, for example, switches, mixers, amplifiers, filters, synthesizer circuitry, control circuitry, etc. In some implementations, the RF interface circuitry 704 transmits and receives wireless signals via, e.g., cells CC0-CC7 illustrated in FIGS. 2-4. In some implementations, the RF interface circuitry 704 reports various UE capabilities relating to multi-cell DCI scheduling.

In the receive path, the RFEM may receive a radiated signal from an air interface via antenna structure 716 and proceed to filter and amplify (with a low-noise amplifier) the signal. The signal may be provided to a receiver of the transceiver that downconverts the RF signal into a baseband signal that is provided to the baseband processor of the processors 702.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 716. In various implementations, the RF interface circuitry 704 may be configured to transmit/receive signals in a manner compatible with NR access technologies.

The antenna 716 may include antenna elements to convert electrical signals into radio waves to travel through the air and to convert received radio waves into electrical signals. The antenna elements may be arranged into one or more antenna panels. The antenna 716 may have antenna panels that are omnidirectional, directional, or a combination thereof to enable beamforming and multiple input, multiple output communications. The antenna 716 may include microstrip antennas, printed antennas fabricated on the surface of one or more printed circuit boards, patch antennas, phased array antennas, etc. The antenna 716 may have one or more panels designed for specific frequency bands including bands in FR1 or FR2.

The user interface 708 includes various input/output (I/O) devices designed to enable user interaction with the UE 700. The user interface 708 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes “LEDs” and multi-character visual outputs), or more complex outputs such as display devices or touchscreens (for example, liquid crystal displays “LCDs,” LED displays, quantum dot displays, projectors, etc.), with the output of characters, graphics, multimedia objects, and the like being generated or produced from the operation of the UE 700.

The sensors 710 may include devices, modules, or subsystems whose purpose is to detect events or changes in its environment and send the information (sensor data) about the detected events to some other device, module, subsystem, etc. Examples of such sensors include, inter alia, inertia measurement units including accelerometers, gyroscopes, or magnetometers; microelectromechanical systems or nanoelectromechanical systems including 3-axis accelerometers, 3-axis gyroscopes, or magnetometers; level sensors; temperature sensors (for example, thermistors); pressure sensors; image capture devices (for example, cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 712 may include software and hardware elements that operate to control particular devices that are embedded in the UE 700, attached to the UE 700, or otherwise communicatively coupled with the UE 700. The driver circuitry 712 may include individual drivers allowing other components to interact with or control various input/output (I/O) devices that may be present within, or connected to, the UE 700. For example, driver circuitry 712 may include a display driver to control and allow access to a display device, a touchscreen driver to control and allow access to a touchscreen interface, sensor drivers to obtain sensor readings of sensor circuitry 728 and control and allow access to sensor circuitry 728, drivers to obtain actuator positions of electro-mechanic components or control and allow access to the electro-mechanic components, a camera driver to control and allow access to an embedded image capture device, audio drivers to control and allow access to one or more audio devices.

The PMIC 714 may manage power provided to various components of the UE 700. In particular, with respect to the processors 702, the PMIC 714 may control power-source selection, voltage scaling, battery charging, or DC-to-DC conversion.

In some implementations, the PMIC 714 may control, or otherwise be part of, various power saving mechanisms of the UE 700. A battery 718 may power the UE 700, although in some examples the UE 700 may be mounted deployed in a fixed location, and may have a power supply coupled to an electrical grid. The battery 718 may be a lithium ion battery, a metal-air battery, such as a zinc-air battery, an aluminum-air battery, a lithium-air battery, and the like. In some implementations, such as in vehicle-based applications, the battery 718 may be a typical lead-acid automotive battery.

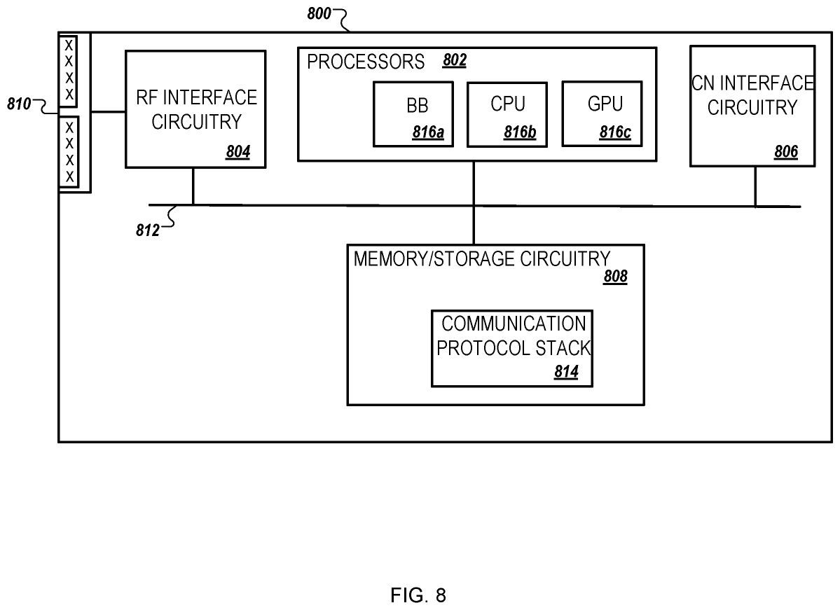

FIG. 8 illustrates an access node 800 (e.g., a base station or gNB), according to some implementations. The access node 800 may be similar to and substantially interchangeable with base station 104. The access node 800 may include processors 802, RF interface circuitry 804, core network (CN) interface circuitry 806, memory/storage circuitry 808, and antenna structure 810.

The components of the access node 800 may be coupled with various other components over one or more interconnects 812. The processors 802, RF interface circuitry 804, memory/storage circuitry 808 (including communication protocol stack 814), antenna structure 810, and interconnects 812 may be similar to like-named elements shown and described with respect to FIG. 7. For example, the processors 802 may include processor circuitry such as, for example, baseband processor circuitry (BB) 816A, CPU 816B, and GPU 816C.

The CN interface circuitry 806 may provide connectivity to a core network, for example, a 5th Generation Core network (5GC) using a 5GC-compatible network interface protocol such as carrier Ethernet protocols, or some other suitable protocol. Network connectivity may be provided to/from the access node 800 via a fiber optic or wireless backhaul. The CN interface circuitry 806 may include one or more dedicated processors or FPGAs to communicate using one or more of the aforementioned protocols. In some implementations, the CN interface circuitry 806 may include multiple controllers to provide connectivity to other networks using the same or different protocols.

As used herein, the terms “access node,” “access point,” or the like may describe equipment that provides the radio baseband functions for data and/or voice connectivity between a network and one or more users. These access nodes can be referred to as BS, gNBs, RAN nodes, eNBs, NodeBs, RSUs, TRxPs or TRPs, and so forth, and can include ground stations (e.g., terrestrial access points) or satellite stations providing coverage within a geographic area (e.g., a cell). As used herein, the term “NG RAN node” or the like may refer to an access node 800 that operates in an NR or 5G system (for example, a gNB), and the term “E-UTRAN node” or the like may refer to an access node 800 that operates in an LTE or 4G system (e.g., an eNB). According to various implementations, the access node 800 may be implemented as one or more of a dedicated physical device such as a macrocell base station, and/or a low power (LP) base station for providing femtocells, picocells or other like cells having smaller coverage areas, smaller user capacity, or higher bandwidth compared to macrocells.

In some implementations, all or parts of the access node 800 may be implemented as one or more software entities running on server computers as part of a virtual network, which may be referred to as a CRAN and/or a virtual baseband unit pool (vBBUP). In V2X scenarios, the access node 800 may be or act as a “Road Side Unit.” The term “Road Side Unit” or “RSU” may refer to any transportation infrastructure entity used for V2X communications. An RSU may be implemented in or by a suitable RAN node or a stationary (or relatively stationary) UE, where an RSU implemented in or by a UE may be referred to as a “UE-type RSU,” an RSU implemented in or by an eNB may be referred to as an “eNB-type RSU,” an RSU implemented in or by a gNB may be referred to as a “gNB-type RSU,” and the like.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

For one or more implementations, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### EXAMPLES

In the following sections, further exemplary embodiments are provided.

Example 1 includes a processor including circuitry that executes instructions to cause a user equipment (UE) to perform operations. The operations include: determining a capability of communicating with a base station using a plurality of cells; identifying, among the plurality of cells, one or more groups of cells, wherein the cells in each group are schedulable by a same downlink control information (DCI) signal in a scheduling cell; determining a number of the one or more groups; and reporting the number of the one or more groups to the base station.

Example 2 includes the processor of example 1, the operations further including: determining a maximum number of the cells in each group; and reporting the maximum number of the cells in each group to the base station.

Example 3 includes the processor of example 1, the operations further including: determining a capability that the cells in each group include the scheduling cell; and reporting the capability to the base station.

Example 4 includes the processor of example 1, the operations further including: determining a capability that the cells in each group do not include the scheduling cell; and reporting the capability to the base station.

Example 5 includes the processor of example 1, the operations further including: determining a capability that the cells in each group have a same subcarrier spacing (SCS); and reporting the capability to the base station.

Example 6 includes the processor of example 1, the operations further including: determining a capability that the cells in each group have different subcarrier spacings (SCSs); and reporting the capability to the base station.

Example 7 includes the processor of example 5, the operations further including: determining a capability that the scheduling cell has the same SCS as the SCS of the cells in each group; and reporting the capability to the base station.

Example 8 includes the processor of example 1, the operations further including: determining a capability that the scheduling cell has a subcarrier spacing (SCS) that is different from the SCS of at least one of the cells in each group; and reporting the capability to the base station.

Example 9 includes the processor of example 1, wherein the reported number includes at least one of: a maximum number of groups of cells supported by the UE; a maximum number of groups of cells supported by each of a first frequency range (FR) and a second FR; a maximum number of groups of cells collectively supported by a plurality of bands; or a maximum number of groups of cells supported by each of the plurality of bands.

Example 10 includes the processor of example 2, wherein the reported maximum number of the cells in each group includes at least one of: a maximum number of the cells in each group supported by the UE; a maximum number of the cells in each group supported by each of a first frequency range (FR) and a second FR; a maximum number of the cells in each group collectively supported by a plurality of bands; or a maximum number of the cells in each group supported by each of the plurality of bands.

Example 11 includes a UE. The UE includes a memory and a processor configured to, when executing instructions stored in the memory, cause the UE to perform operations of those described in examples 1-10.

Example 12 may include one or more non-transitory computer-readable media including instructions to cause an electronic device, upon execution of the instructions by one or more processors of the electronic device, to perform one or more elements of a method described in or related to any of examples 1-10, or any other method or process described herein.

Example 13 may include an apparatus including logic, modules, or circuitry to perform one or more elements of a method described in or related to any of examples 1-10, or any other method or process described herein.

Example 14 may include a method, technique, or process as described in or related to any of examples 1-10, or portions or parts thereof.

Example 15 may include an apparatus including: one or more processors and one or more computer-readable media including instructions that, when executed by the one or more processors, cause the one or more processors to perform the method, techniques, or process as described in or related to any of examples 1-10, or portions thereof.

Example 16 may include a signal as described in or related to any of examples 1-10, or portions or parts thereof.

Example 17 may include a datagram, information element, packet, frame, segment, PDU, or message as described in or related to any of examples 1-10, or portions or parts thereof, or otherwise described in the present disclosure.

Example 18 may include a signal encoded with data as described in or related to any of examples 1-10, or portions or parts thereof, or otherwise described in the present disclosure.

Example 19 may include a signal encoded with a datagram, IE, packet, frame, segment, PDU, or message as described in or related to any of examples 1-10, or portions or parts thereof, or otherwise described in the present disclosure.

Example 20 may include an electromagnetic signal carrying computer-readable instructions, wherein execution of the computer-readable instructions by one or more processors is to cause the one or more processors to perform the method, techniques, or process as described in or related to any of examples 1-10, or portions thereof.

Example 21 may include a computer program including instructions, wherein execution of the program by a processing element is to cause the processing element to carry out the method, techniques, or process as described in or related to any of examples 1-10, or portions thereof. The operations or actions performed by the instructions executed by the processing element can include the methods of any one of examples 1-10.

Example 22 may include a signal in a wireless network as shown and described herein.

Example 23 may include a method of communicating in a wireless network as shown and described herein.

Example 24 may include a system for providing wireless communication as shown and described herein. The operations or actions performed by the system can include the methods of any one of examples 1-10.

Example 25 may include a device for providing wireless communication as shown and described herein. The operations or actions performed by the device can include the methods of any one of examples 1-10.

The previously-described examples 1-10 are implementable using a computer-implemented method; a non-transitory, computer-readable medium storing computer-readable instructions to perform the computer-implemented method; and a computer system including a computer memory interoperably coupled with a hardware processor configured to perform the computer-implemented method or the instructions stored on the non-transitory, computer-readable medium.

Any of the above-described examples may be combined with any other example (or combination of examples), unless explicitly stated otherwise. The foregoing description of one or more implementations provides illustration and description, but is not intended to be exhaustive or to limit the scope of implementations to the precise form disclosed. Modifications and variations are possible in light of the above teachings or may be acquired from practice of various implementations.

Although the implementations above have been described in considerable detail, numerous variations and modifications will become apparent to those skilled in the art once the above disclosure is fully appreciated. It is intended that the following claims be interpreted to embrace all such variations and modifications.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

1-20. (canceled)

21. One or more processors configured to, when executing instructions stored in a memory, perform operations comprising:
instructing radio frequency (RF) circuitry to transmit capability signaling that indicates whether a user equipment (UE) supports monitoring downlink control information (DCI) for multi-cell physical uplink shared channel (PUSCH) scheduling information;
receiving, via a scheduling cell, DCI comprising multi-cell PUSCH scheduling information for a set of cells; and
instructing the RF circuitry to transmit, via the set of cells, a respective set of PUSCH transmissions in accordance with the capability signaling and the multi-cell PUSCH scheduling information.

22. The one or more processors of claim 21, wherein the scheduling cell and the set of cells scheduled by the DCI have the same subcarrier spacing (SCS).

23. The one or more processors of claim 21, wherein the scheduling cell and the set of cells scheduled by the DCI have different subcarrier spacings (SCS).

24. The one or more processors of claim 21, wherein the scheduling cell is included in the set of cells scheduled by the DCI.

25. The one or more processors of claim 21, wherein the scheduling cell is not included in the set of cells scheduled by the DCI.

26. The one or more processors of claim 21, the operations further comprising determining a number of physical downlink control channel (PDCCH) candidates and a corresponding number of control channel elements (CCEs) based at least in part on whether the scheduling cell is included in the set of cells.

27. The one or more processors of claim 26, wherein the number of PDCCH candidates and the corresponding number of CCEs are determined with respect to the scheduling cell or a serving cell in the set of cells scheduled by the DCI.

28. The one or more processors of claim 21, wherein the capability signaling further indicates a maximum number of co-scheduled cells per set of cells supported by the UE.

29. The one or more processors of claim 21, wherein the capability signaling further indicates a maximum number of sets of cells supported by the UE for a same scheduling cell.

30. The one or more processors of claim 21, wherein the capability signaling is reported per band combination.

31. The one or more processors of claim 21, wherein receiving the DCI comprises monitoring a plurality of physical downlink control channel (PDCCH) candidates on the scheduling cell for detection of the DCI.

32. The one or more processors of claim 21, wherein the capability signaling pertains to serving cells in Frequency Range 1 (FR1) or Frequency Range 2 (FR2).

33. One or more processors configured to, when executing instructions stored in a memory, perform operations comprising:
receiving capability signaling that indicates whether a user equipment (UE) supports monitoring downlink control information (DCI) for multi-cell physical uplink shared channel (PUSCH) scheduling information;
instructing radio frequency (RF) circuitry to transmit, via a scheduling cell, DCI comprising multi-cell PUSCH scheduling information for a set of cells; and
receiving, via a serving cell of the set of cells, a PUSCH transmission in accordance with the capability signaling and the multi-cell PUSCH scheduling information.

34. The one or more processors of claim 33, wherein the scheduling cell and the set of cells scheduled by the DCI have the same subcarrier spacing (SCS).

35. The one or more processors of claim 33, wherein the scheduling cell and the set of cells scheduled by the DCI have different subcarrier spacings (SCS).

36. The one or more processors of claim 33, wherein the scheduling cell is included in the set of cells scheduled by the DCI.

37. The one or more processors of claim 33, wherein the scheduling cell is not included in the set of cells scheduled by the DCI.

38. The one or more processors of claim 33, wherein the capability signaling further indicates a maximum number of co-scheduled cells per set of cells supported by the UE.

39. The one or more processors of claim 33, wherein the capability signaling further indicates a maximum number of sets of cells supported by the UE for a same scheduling cell.

40. A method comprising:
transmitting capability signaling that indicates whether a user equipment (UE) supports monitoring downlink control information (DCI) for multi-cell physical uplink shared channel (PUSCH) scheduling information;
receiving, via a scheduling cell, DCI comprising multi-cell PUSCH scheduling information for a set of cells; and
transmitting, via the set of cells, a respective set of PUSCH transmissions in accordance with the capability signaling and the multi-cell PUSCH scheduling information.
